(19) United States
(12) Patent Application Publication
(10) Pub. No.: US 2005/0050455 A1
(43) Pub. Date: Mar. 3, 2005

(54) Method and apparatus for supporting object caching in a web presentation architecture

(76) Inventors: Sunny K. Yee, Palo Alto, CA (US); Peter Christopher Johnson, II, Riverside, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/652,388

(22) Filed: Aug. 29, 2003

(51) Int. Cl. G06F 15/00

(52) U.S. Cl. 715/513

(57) ABSTRACT

The disclosed embodiments relate to a system and method that create web applications. The system comprises a controller generator that is adapted to provide a web application with a controller that receives requests for data from users and responds to the requests by obtaining requested data. The system also comprises a cache generator that is adapted to provide a cache for use by the web application, the cache being adapted to store data requested from an external data source, wherein data stored in the cache is accessible by the controller in response to subsequent requests for that data without re-obtaining the data from the external source.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Web applications that allow a user to access data from external sources such as large databases or other websites continue to grow in usefulness and popularity. Back end data stores and web services are examples of external sources of information that may be accessed by web applications. Web applications that allow access to external data may be very powerful because they may allow a user to access large amounts of data from a variety of sources and have that information displayed in an effective format.

A potential problem with present architectures for web applications is that those architectures provide for web applications that require requested data to be retrieved separately for each hyper text transfer protocol (“HTTP”) request received by the web application from a user. Even if a user requests similar data using successive HTTP requests, the data must be retrieved from the external source for each HTTP request before it may be used to build a web page that is displayed to the user.

In addition, different users from the same company or organization may request similar data from a database or other external source. Currently, both users must wait for the data to be retrieved responsive to their individual HTTP requests before web pages may be built and displayed to them. The delay in obtaining data requested from an outside entity such as a back end data store or a web service may be significant. Web applications generated using current architectures are able to cache HTML code generated during a user session, but no provision is made to provide applications that make data retrieved from an external source available outside the context of a specific HTTP request.

### BRIEF DESCRIPTION OF THE DRAWINGS

Advantages of one or more disclosed embodiments may become apparent upon reading the following detailed description and upon reference to the drawings in which:

FIG. 1 is a block diagram that illustrates a model-view-controller (“MVC”) application architecture, which may be created using embodiments of the present invention;

FIG. 2 is a block diagram that illustrates a web presentation architecture in accordance with embodiments of the present invention;

FIG. 3 is a block diagram that illustrates the operation of a web application program created using a web presentation architecture in accordance with embodiments of the present invention; and

FIG. 4 is an object diagram of a cache architecture in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

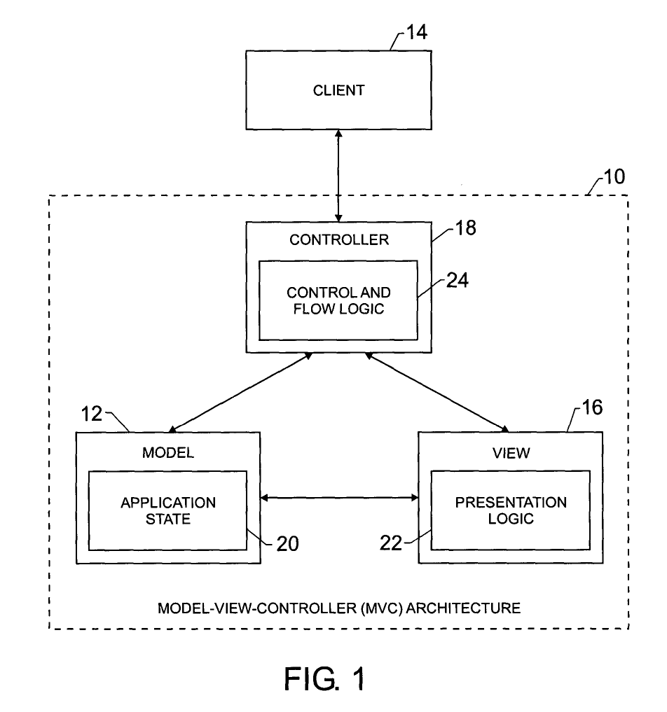

FIG. 1 is a block diagram that illustrates a model-view-controller (“MVC”) application architecture, which may be created using embodiments of the present invention. As illustrated, the MVC architecture 10 separates the application object or model 12 from a view 16, which is responsible for receiving input and presenting output to a client 14. In a web application context, the client 14 may comprise a browser. The model object and the view are also separated from the control functions of the application, which are represented in FIG. 1 as a controller 18. In general, the model 12 comprises an application state 20, the view 16 comprises presentation logic 22, and the controller 18 comprises control and flow logic 24. By separating these three MVC objects 12, 16, and 18 with abstract boundaries, the MVC architecture 10 provides flexibility, organization, performance, efficiency, and reuse of data, presentation styles, and logic.

The WPA 100 may be configured with a variety of object-oriented programming languages, such as Java by Sun Microsystems, Inc., Santa Clara, Calif. An object is generally any item that can be individually selected and manipulated. In object-oriented programming, an object may comprise a self-contained entity having data and procedures to manipulate the data. For example, a Java-based system may utilize a variety of JavaBeans, servlets, Java Server Pages, and so forth. JavaBeans are independent, reusable software modules. In general, JavaBeans support introspection (a builder tool can analyze how a JavaBean works), customization (developers can customize the appearance and behavior of a JavaBean), events (JavaBeans can communicate), properties (developers can customize and program with JavaBeans), and persistence (customized JavaBeans can be stored and reused). JSPs provide dynamic scripting capabilities that work in tandem with HTML code, separating the page logic from the static elements. According to certain embodiments, the WPA 100 may be designed according to the Java 2 Platform Enterprise Edition (J2EE), which is a platform-independent, Java-centric environment for developing, building and deploying multi-tiered Web-based enterprise applications online.

The model 12 comprises a definitional framework representing the application state 20. For example, in a web-based application, the model 12 may comprise a JavaBean object or other suitable means for representing the application state 20. Regardless of the application or type of object, an exemplary model 12 may comprise specific data and expertise or ability (methods) to get and set the data (by the caller). The model 12 generally focuses on the intrinsic nature of the data and expertise, rather than the extrinsic views and extrinsic actions or business logic to manipulate the data. However, depending on the particular application, the model 12 may or may not contain the business logic along with the application state. For example, a large application having an application tier may place the business logic in the application tier rather than the model objects 12 of the web application, while a small application may simply place the business logic in the model objects 12 of the web application.

As noted above, the view and controller objects 16 and 18 separately address these extrinsic views and actions or business logic. For example, the model 12 may represent data relating to a person (e.g., an address, a birth date, phone number, etc.), yet the model 12 is independent of extrinsic formats (e.g., a date format) for displaying the personal data or extrinsic actions for manipulating the personal data (e.g., changing the address or phone number). Similarly, the model 12 may represent data and expertise to track time (e.g., a clock), yet the model 12 is independent of specific formats for viewing the clock (e.g., analog or digital clock) or specific actions for manipulating the clock (e.g., setting a different time zone). These extrinsic formats and extrinsic actions are simply not relevant to the intrinsic behavior of the model clock object. One slight exception relates to graphical model objects, which inherently represent visually perceptible data. If the model 12 represents a particular graphical object, then the model 12 has expertise to draw itself while remaining independent of extrinsic formats for displaying the graphical object or extrinsic actions for creating or manipulating the graphical object.

The view 16 generally manages the visually perceptible properties and display of data, which may be static or dynamic data derived in whole or in part from one or more model objects 12. As noted above, the presentation logic 22 functions to obtain data from the model 12, format the data for the particular application, and display the formatted data to the client 14. For example, in a web-based application, the view 16 may comprise a Java Server Page (JSP page) or an HTML page having presentation logic 22 to obtain, organize, format, and display static and/or dynamic data. Standard or custom action tags (e.g., jsp:useJavaBean) may function to retrieve data dynamically from one or more model objects 12 and insert model data within the JSP pages. In this manner, the MVC architecture 10 may facilitate multiple different views 16 of the same data and/or different combinations of data stored by one or more model objects 12.

The controller 18 functions as an intermediary between the client 14 and the model object 12 and view 16 of the application. For example, the controller 18 can manage access by the view 16 to the model 12 and, also, manage notifications and changes of data among objects of the view 16 and objects of the model 12. The control and flow logic 24 of the controller 18 also may be subdivided into model-controllers and view-controllers to address and respond to various control issues of the model 12 and the view 16, respectively. Accordingly, the model-controllers manage the models 12 and communicate with view-controllers, while the view-controllers manage the views 16 and communicate with the model-controllers. Subdivided or not, the controllers 18 ensure communication and consistency between the model 12 and view 16 and the client 14.

In operation, the control and flow logic 24 of the controller 18 generally receives requests from the client 14, interprets the client requests, identifies the appropriate logic function or action for the client requests, and delegates responsibility of the logic function or action. Requests may be received from the client via a number of protocols, such as Hyper Text Transfer Protocol (“HTTP”) or HTTP with Secure Sockets Layer (“HTTPS”). Depending on the particular scenario, the appropriate logic function or action of the controller 18 may include direct or indirect interaction with the view 16 and/or one or more model objects 12. For example, if the appropriate action involves alteration of extrinsic properties of data (e.g. reformatting data in the view 16), then the controller 18 may directly interact with the view 16 without the model 12. Alternatively, if the appropriate action involves alteration of intrinsic properties of data (e.g., values of data in the model 12), then the controller 18 may act to update the corresponding data in the model 12 and display the data in the view 16.

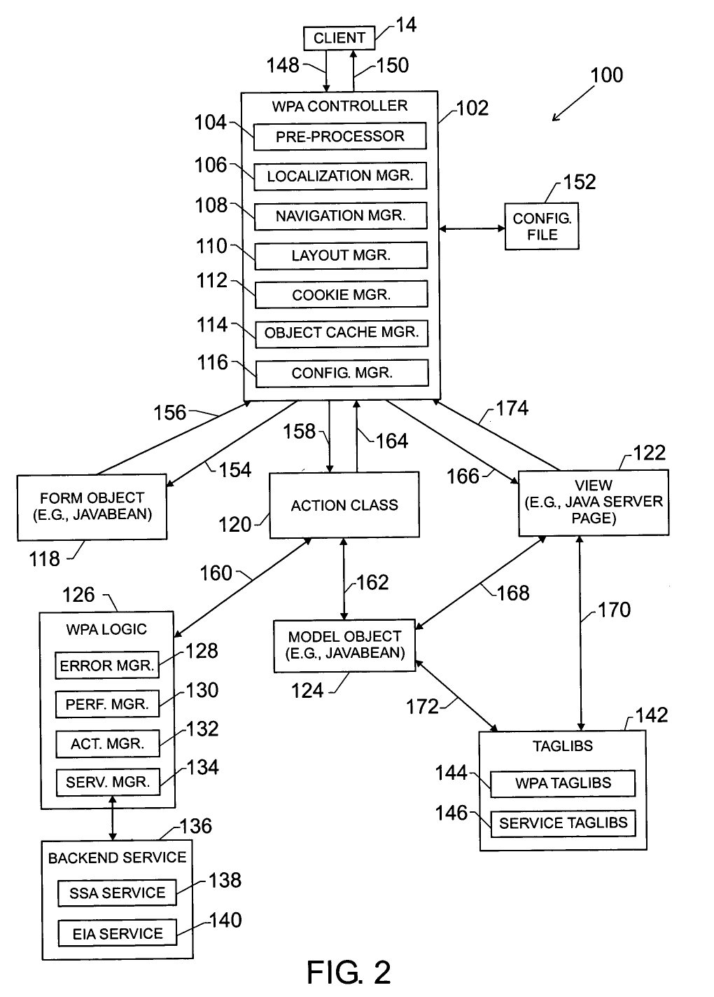

FIG. 2 is a block diagram illustrating an exemplary web presentation architecture (“WPA”) 100 in accordance with certain embodiments of the present invention. The illustrated WPA 100, which may be adapted to execute on a processor-based device such as a computer system or the like, has certain core features of the MVC computing strategy, and various additional features and enhancements to improve its architectural operation and performance. For example, the illustrated WPA 100 separates the model, the view, and the controller as with the traditional MVC architecture, yet the WPA 100 provides additional functionality to promote modularity, flexibility, and efficiency.

As illustrated, the WPA 100 comprises a WPA controller 102 having a preprocessor 104, a localization manager 106, the navigation manager 108, a layout manager 110, a cookie manager 112, and object cache manager 114, and a configurator or configuration manager 116. The WPA controller 102 functions as an intermediary between the client 14, form objects 118, action classes 120, and views 122. In turn, the action classes 120 act as intermediaries for creating/manipulating model objects 124 and executing WPA logic 126, such as an error manager 128, a performance manager 130, and activity manager 132, and a backend service manager 134. As described below, the backend service manager 134 functions to interface backend services 136. Once created, the model objects 124 can supply data to the view 122, which can also call various tag libraries 142 such as WPA tag libraries 144 and service tag libraries 146.

In operation, the client 14 sends a request 148 to the WPA 100 for processing and transmission of a suitable response 150 back to the client 14. For example, the request 148 may comprise a data query, data entry, data modification, page navigation, or any other desired transaction. As illustrated, the WPA 100 intakes the request 148 at the WPA controller 102, which is responsible for various control and flow logic among the various model-view-controller divisions of the WPA 100. For example, the WPA controller 102 can be implemented as a Servlet, such as a HyperText Transfer Protocol (“HTTP”) Servlet, which extends the ActionServlet class of Struts (an application framework promulgated by the Jakarta Project of the Apache Software Foundation). As illustrated, the WPA controller 102 invokes a configuration resource file 152, such as struts-config.xml, which provides mapping information for form classes, action classes, and other objects. Based on the particular request 148, the WPA controller 102 locates the appropriate action class and, also, the appropriate form class if the request 148 contains form data (e.g., client data input). For example, the WPA controller 102 may lookup a desired WPA Action Form and/or WPA Action Class, which function as interfaces to WPA Form Objects and WPA Action Objects.

If the client entered data, then the WPA controller 102 creates and populates the appropriate form object 118 as indicated by arrow 154. The form object 118 may comprise any suitable data objects type, such as a JavaBean, which functions to store the client entered data transmitted via the request 148. The WPA controller 102 then regains control as indicated by arrow 156.

If the client did not enter data, or upon creation and population of the appropriate form object 118, then the WPA controller 102 invokes the action class 120 to execute various logic suitable to the request 148 as indicated by arrow 158. For example, the action class 120 may call and execute various business logic or WPA logic 126, as indicated by arrow 160 and discussed in further detail below. The action class 120 then creates or interacts with the model object 124 as indicated by arrow 162. The model object 124 may comprise any suitable data object type, such as a JavaBean, which functions to maintain the application state of certain data. One example of the model object 124 is a shopping cart JavaBean, which stores various user data and e-commerce items selected by the client. However, a wide variety of model objects 124 are within the scope of the WPA 100. After executing the desired logic, the action class 120 forwards control back to the WPA controller 102 as indicated by arrow 164, which may be referred to as an “action forward.” This action forward 164 generally involves transmitting the path or location of the server-side page, e.g., the JSP.

As indicated by arrow 166, the WPA controller 12 then invokes the foregoing server-side page as the view 122. Accordingly, the view 122 interprets its links or tags to retrieve data from the model object 124 as indicated by arrow 168. Although a single model object 124 is illustrated, the view 122 may retrieve data from a wide variety of model objects. In addition, the view 122 interprets any special logic links or tags to invoke tag libraries 142 as indicated by arrow 170. For example, the WPA tag libraries 144 and the service tag libraries 146 can include various custom or standard logic tag libraries, such as<html>, <logic>, <template> developed as part of the Apache Jakarta Project or the like. Accordingly, the tag libraries 142 further separate the logic from the content of the view 122, thereby facilitating flexibility and modularity. In certain cases, the tag libraries 142 also may interact with the model object 124 as indicated by arrow 172. For example, a special tag may execute logic to retrieve data from the model object 124 and manipulate the retrieved data for use by the view 122. After interacting with the model object 124 and the appropriate tag libraries 142, the WPA 100 executes the view 122 (e.g., JSP) to create a client-side page for the client 14 as indicated by arrow 174. For example, the client-side page may comprise an XML or HTML formatted page, which the WPA controller 102 returns to the client 14 via the response 150.

As discussed above, the WPA 100 comprises a variety of unique logic and functional components, such as control components 104 through 116 and logic 128 through 134, to enhance the performance of the overall architecture and specific features 100. These components and logic generally operate on the server-side of the WPA 100, yet there are certain performance improvements that may be apparent on the client-side. These various components, while illustrated as subcomponents of the controller 102 or types of logic 126, may be standalone or integrated with various other portions of the WPA 100. Accordingly, the illustrated organization of these components is simply one exemplary embodiment of the WPA 100, while other organizational embodiments are within the scope of the present technique.

Turning to the subcomponents of the WPA controller 102, the preprocessor 104 provides preprocessing of requests by configuring portal specific functions to execute for each incoming request registered to the specific portal. The preprocessor 104 identifies the appropriate portal specific functions according to a preset mapping, e.g., a portal-to-function mapping in the configuration file 152. Upon completion, the preprocessor 104 can redirect to a remote Uniform Resource Identifier (URI), forward to a local URI, or return and continue with the normal processing of the request 148 by the WPA controller 102. One example of such a preprocessing function is a locale, which is generally comprised of language preferences, location, and so forth. The preprocessor 104 can preprocess local logic corresponding to a particular portal, thereby presetting language preferences for subsequent pages in a particular application.

The locale information is also used by the localization manager 106, which functions to render localized versions of entire static pages rather than breaking up the static page into many message strings or keys. Instead of using a single page for all languages and obtaining localized strings from other sources at run time, the localization manager 106 simply looks up a localized page according to a locale identifier according to a preset mapping, e.g., a locale-to-localized page mapping in the configuration file 152.

The navigation manager 108 generally functions to save a users intended destination and subsequently recall that information to redirect the user back to the intended destination. For example, if the user intends to navigate from point A to point B and point B queries for certain logic at point C (e.g., a user login and password), then the navigation manager 108 saves the address of point B, proceeds to the requested logic at point C, and subsequently redirects the user back to point B.

The layout manager 110 enables a portal to separate the context logic functioning to render the common context from the content logic functioning to render the content portion of the page. The common context (e.g., C-Frame) may include a top portion or header, a bottom portion or footer, and a side portion or sidebar, which collectively provides the common look and feel and navigational context of the page.

The cookie manager 112 functions to handle multiple cookie requests and to set the cookie value based on the most recent cookie request before committing a response. For example, in scenarios where multiple action classes attempt to set a particular cookie value, the cookie manager 112 caches the various cookie requests and defers setting the cookie value until response time. In this manner, the cookie manager 112 ensures that different action classes do not erase cookie values set by one another and, also, that only one cookie can exist with a particular name, domain, and path.

The object cache manager 114 enables applications to create customized in-memory cache for storing objects having data originating from backend data stores, such as databases or service based frameworks (e.g., Web Services Description Language “WSDL”). The in-memory cache may be customized according to a variety of criteria, such as cache size, cache scope, cache replacement policy, and time to expire cache objects. In operation, the object cache manager 114 improves performance by reducing processing time associated with the data from the backend data stores. Instead of retrieving the data from the backend data stores for each individual request 148, the object cache manager 114 caches the retrieved data for subsequent use in processing later requests.

The configurator or configuration manager 116 functions to load repeatedly used information, such as an error code table, into memory at startup time of a particular web application. The configuration manager 116 retains this information in memory for the duration of a session, thereby improving performance by eliminating the need to load the information each time the server receives a request.

Turning to the WPA logic 126, the error handler or manager 128 functions to track or chain errors occurring in series, catalog errors messages based on error codes, and displaying error messages using an error catalog. The error catalog of the error manager 128 may enable the use of generic error pages, which the error manager 128 populates with the appropriate error message at run time according to the error catalog.

The WPA logic function 126 may comprise performance and activity managers 130 and 132, which may facilitate tracking and logging of various information associated with a particular transaction or request. The error manager 128 may also be adapted to participate in tracking and logging operations as well.

The service manager 134 of the WPA logic 126 functions as an interface between the WPA 100 and various backend services 136. In operation, the service manager 134 communicates with the desired backend service 136 according to the client request 148, parses a response from the backend service 136 to obtain the appropriate data, and pass it to the appropriate object of WPA 100.

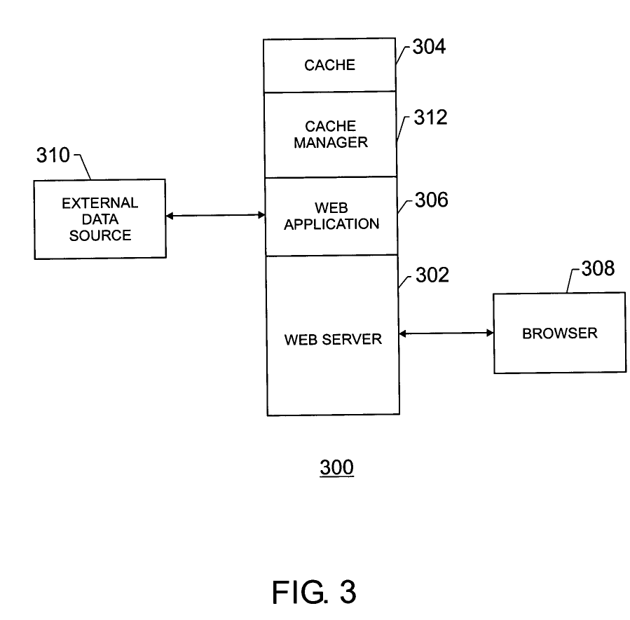

FIG. 3 is a block diagram that illustrates the operation of a web application program created using a web presentation architecture in accordance with embodiments of the present invention. The diagram in general is referred to by the reference numeral 300.

A web server 302 hosts a web application 306, which is configured to access an external data source 310, such as a back end data store or a web service provided by another website. Although only one external data source 310 is illustrated in FIG. 3, those of ordinary skill in the art will appreciate that multiple external data sources may be accessed by the web application 306. The web application 306 is adapted to receive requests for data, which may take the form of HTTP requests or the like, from a browser 308.

The web application 306 is adapted to store data retrieved from the external data source 310 in a cache 304. A cache manager 312 may operate in conjunction with the web application 306 to manage the cache 304. Those of ordinary skill in the art will appreciate that the cache manager 312 may be incorporated as a portion of the web application 306. If data is stored in the cache 304 after the data is obtained by a first user request, that data does not have to be retrieved from the external data source 310 if the user requests the same data at a later time via a second HTTP request or the like.

Additionally, the web application 306 may be configured to allow access to cached data by a single user or groups of users. If access to cached data is permitted by a group of users, such access may be controlled, for example, by allowing access to specific regions of cached data by users who access the web application 306 via the same web portal as other users. In this way, user access can be restricted to members of a specific organization or company who may each be assigned a specific web portal to access the web application 306. Users accessing the web application 306 through a different web portal may be permitted access to a different area of cached data, but may not be permitted access to data cached for users who accessed the web application 306 via a different web portal.

Web presentation architectures constructed in accordance with embodiments of the present invention may provide the capability for application developers to set up customized in-memory caches for storing objects in application or session scope. Each cache 304 may be customized by its cache size, cache scope, cache object replacement policy and cache object expiration time. Data object caching may be more effective if data from the external source 310 is static.

Web presentation architectures in accordance with embodiments of the present invention may provide a set of cache classes based on cache classes from known sources, such as the Jakarta-ORO project. Each cache class may be required to implement a common cache interface.

The cache 304 may store a set of objects in application or session scope up to a defined capacity, with a cache replacement policy for replacing (removing) objects when the cache is full. There is not necessarily any restriction on the number of caches allowed. Object expiration may be available to invalidate objects after some defined interval. Expiration may be implemented to work along with a cache replacement policy. For example, if adding an object to the cache when the cache is full, object expiration checking may be invoked first to remove any expired objects. If expired objects are found and removed, then replacement policy is not necessary to remove active objects when adding a new object.

The interface for the cache 304 may specify the following methods: AddObject(HttpServletRequest, name, value)—add an object to the cache. This method may contain logic to check to see if the cache is full. If the cache is full, then the AddObject method may remove expired objects if object expiration is enabled. Additionally, the AddObject method may also contain logic to perform the replacement policy.

getObject(key)—return an object with the key (key). This method may contain logic to check if an object is found in the cache. If the object is in the cache and expired, the object may be removed from the cache. If the object is expired or not present, a null value may be returned. Otherwise, the object requested may be returned.

getCapacity( )—return the cache capacity that the cache can hold.

getSize( )—return the number of objects in the cache.

deleteObject(key)—delete object with the key (key) from the cache.

isFull( )—return a boolean indicating whether the cache is full.

getKeys( )—return a key or keys that may be used for retrieving the list of objects in the cache.

activateCache( )—initialize and set up the cache for the current session or application scope. This method may be required for a cache in session scope because there is a cache for each user session and this method will set the correct cache for the current user session. During the request processing, the cache for the current session may be activated through this method. In each client request, this method is called within the getCache( ) method of the cache manager for the application developer.

Embodiments of the present invention may provide a set of concrete cache classes that applications may use. The cache classes may implement the cache interface and may wrap existing cache classes, such as the cache classes from Jakarta-ORO. Examples of cache classes that may wrap Jakarta-ORO cache classes include:
WPACacheFIFO (first-in-first-out)
WPACacheFIFO2 (second chance first-in-first-out)
WPACacheLRU (least recently used)
WPACacheRandom (randomly selected)
   Web applications, such as the web application 306, may be designed to create their own cache classes if the existing cache classes are not appropriate for their use.

Developers of web applications may access the cache 304 from the cache manager 312. The object cache manager 312 may provide the method to return a cache instance that developers may use to interact with their cache. The cache manager 312 may maintain the list of caches created during application startup, so that the architectural framework can easily track the cache for memory usage.

Each cache 304 may be defined by a record in a cache.xml file, which may be located in a specific directory (for example, /WEB-INF/<service>/properties). The cache.xml file may be read during startup by a configurator, such as an object cache startup configurator. The object cache startup configurator may create a cache class object for each cache record found in the XML file.

Each cache record in the XML file may be designed to include the following fields:

Cache name—a cache is referenced by this name in the code, required field.

Cache class name—instantiate object for this interface of cache, required field.

Cache scope—store cache in application or session scope, optional field, default is session scope.

Cache capacity—maximum objects to store in cache, optional field, a default value, such as 20 objects, may be specified.

Object expiration in seconds—expire objects N seconds after last used, optional field, a default value, such as 60 minutes, may be specified. An expiration check may be made prior to returning an object from a getElement( ) method. Object expiration may be disabled by setting the object expiration variable to a predetermined value, such as −1.

Check expiration interval in seconds—perform object expiration check after N intervals have passed since the last check. This check may be made only within an add cache object method (addObject( )) or a get cache object list method (getKeys( )). A default value, such as five minutes, may be specified. The object expiration check is not applicable if object expiration is disabled.

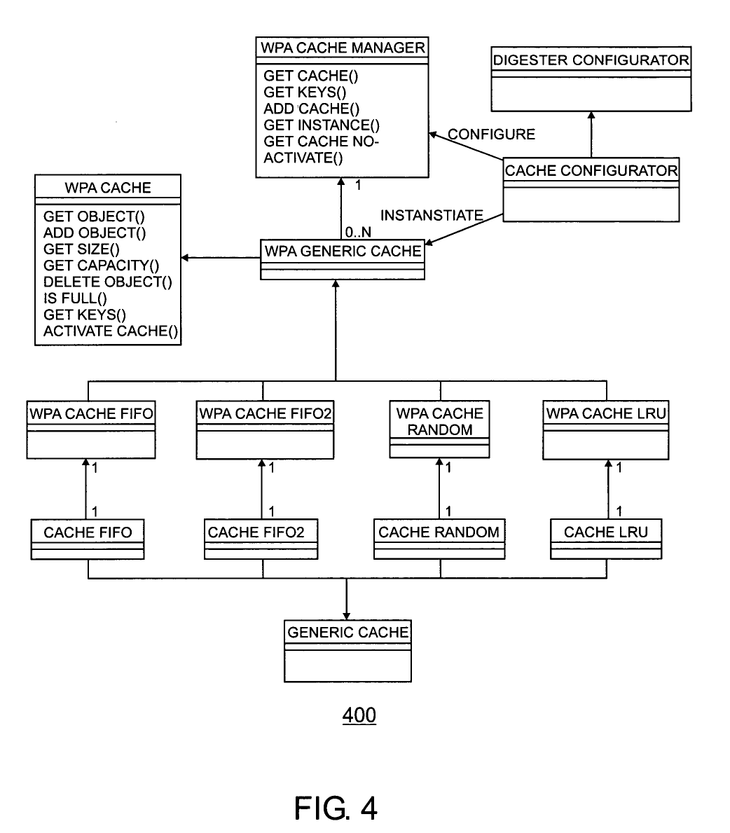

FIG. 4 is an object diagram of a cache architecture in accordance with embodiments of the present invention. The diagram is generally referred to by the reference numeral 400. FIG. 4 is useful in identifying the relationship between various objects referred to in the above examples.

With respect to Jakarta-ORO cache classes in the object model, those cache classes do not provide methods to remove elements from the cache, but with object expiration capability, it may be necessary to explicitly remove elements from the cache. Methods may be provided to support deleting objects from the cache, and to reuse data structures from deleted objects.

The data structure for an ORO cache may be a hash map that maps cache object names to cache objects. In each cache constructor, an array of GenericCacheEntry objects of array size set to the cache capacity is allocated. The GenericCacheEntry class may contain the object name, object (value), and array index.

In a cache object delete operation, the cache object may be removed from the cache, and the GenericCacheEntry array element space is marked as unused for reuse. A different array maintaining a list of indices to unused GenericCacheEntry locations may be created. In a cache object add operation for all the ORO Cache classes, the operations may first check to determine if there is any available unused space to use before using a new space in the array, or replacing an object that has not expired when the cache is full.

The following methods may be added to the GenericCache class of Jakarta-ORO GenericCache class for object caching:
deleteElement(key)—delete element (key) from the cache.
findUnusedSlot( )—return the next unused index from the GenericCacheEntry array for adding new cache objects to the cache.
hasUnusedSlots( )—return a boolean indicating whether there is any unused slots for reuse.

The following examples of code represent various aspects of a web presentation architecture in accordance with embodiments of the present invention. Those of ordinary skill in the art will appreciate that these code examples are given for purposes of illustration only, and not by way of limitation. The following is an example of a cache.xml file defining two caches:

```
<cache-list>
  <cache name=“CKI.SearchResult”
    className=“com.cache.WPACacheFIFO”
    scope=“session”
    capacity=“20”
    expireSecs=“3600”
    checkIntervalSecs=“300”/>
  <cache name=“Patch.PatchList”
    className=“com.cache.WPACacheLRU”
    scope=“application”
    capacity=“50”
    expireSecs=“600”
    checkIntervalSecs=“300”/>
</cache-list>
```

The following code sample shows how to access the cache, and then get an object from the cache and add an object to the cache:

```
import com.cache.WPACacheManager;
import com.cache.WPACache;
public class SomeAction extends WPAAction {
  public ActionForward perform(*ActionMapping mapping,
        ActionForm form,
        HttpServletRequest request,
        HttpServletResponse response) {
    WPACacher myCache = (WPACache)
      WPACacheManager.getInstance().getCache(“CKI.SearchResult”);
    Object aObject = myCache.getObject(“aObjectName”);
    If (aObject != null) {
      // Got my object from cache
    }
    else {
      // Didn't get my object from cache
    }
    // Add an object to the cache
    myCache.addObject(request, aObjectName2, aObject2);
```

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system for creating web applications, the system comprising:
a controller generator that is adapted to provide a web application with a controller that receives requests for data from users and responds to the requests by obtaining requested data; and
a cache generator that is adapted to provide a cache for use by the web application, the cache being adapted to store data requested from an external data source, wherein data stored in the cache is accessible by the controller in response to subsequent requests for that data without re-obtaining the data from the external source.

2. The system set forth in claim 1, wherein the cache generator is adapted to allow the creation of a separate cache for each of a plurality of portals that provide access to the web application.

3. The system set forth in claim 2, wherein the cache generator is adapted to allow the cache associated with a specific one of the plurality of portals to be accessible only by users who access the web application through the specific one of the plurality of portals.

4. The system set forth in claim 1, wherein the cache generator is adapted to provide a cache attribute to specify the size of the cache.

5. The system set forth in claim 1, wherein the cache generator is adapted to provide a cache attribute to specify a length of time to maintain the cache in a memory.

6. The system set forth in claim 1, wherein the cache generator is adapted to provide a cache attribute to specify a cache replacement policy for the cache.

7. The system set forth in claim 1, wherein the cache generator is adapted to provide a cache attribute to specify a cache expiration policy for the cache.

8. A method of creating web applications, the method comprising:
creating, with a processor-based device, a controller that receives requests for data from users and responds to the requests by obtaining requested data; and
providing a cache for use by a web application, the cache being adapted to store data requested from an external data source, wherein data stored in the cache is accessible by the controller in response to subsequent requests for that data without re-obtaining the data from the external source.

9. The method set forth in claim 8, comprising defining a cache generator that allows the creation of a separate cache for each of a plurality of portals that provide access to the web application.

10. The method set forth in claim 9, comprising defining a cache generator that allows the cache associated with a specific one of the plurality of portals to be accessible only by users who access the web application through the specific one of the plurality of portals.

11. The method set forth in claim 8, comprising defining a cache generator that provides a cache attribute to specify the size of the cache.

12. The method set forth in claim 8, comprising defining a cache generator that provides a cache attribute to specify a length of time to maintain the cache in a memory.

13. The method set forth in claim 8, comprising defining a cache generator that provides a cache attribute to specify a cache replacement policy for the cache.

14. The method set forth in claim 8, comprising defining a cache generator that provides a cache attribute to specify a cache expiration policy for the cache.

15. The method set forth in claim 8, wherein the recited acts are performed in the recited order.

16. A system for creating web applications, the system comprising:
means for creating a controller that provides control functions for a web application, the controller being adapted to receive requests for data from users and respond to the requests by obtaining requested data; and
means for providing a cache that stores data for the web application, the cache being adapted to store data requested from an external data source, wherein data stored in the cache is accessible by the controller in response to subsequent requests for that data without re-obtaining the data from the external source.

17. The system set forth in claim 16, wherein the external data source is a web site external to the web application.

18. The system set forth in claim 16, wherein the external data source is a web service external to the web application.

19. The system set forth in claim 16, wherein the means for providing a cache is adapted to allow the creation of a separate cache for each of a plurality of portals that provide access to the web application.

20. The system set forth in claim 19, wherein the means for providing a cache is adapted to allow the cache associated with a specific one of the plurality of portals to be accessible only by users who access the web application through the specific one of the plurality of portals 21. A program for creating a web application, the program comprising:
a machine readable medium;
a controller generator stored on the machine readable medium, the controller generator being adapted to provide a web application with a controller that receives requests for data from users and responds to the requests by obtaining requested data; and
a cache generator stored on the machine readable medium, the cache generator being adapted to provide a cache for use by the web application, the cache being adapted to store data requested from an external data source, wherein data stored in the cache is accessible by the controller in response to subsequent requests for that data without re-obtaining the data from the external source.
